(19) United States
(12) Patent Application Publication
(10) Pub. No.: US 2026/0239145 A1
(43) Pub. Date: Aug. 13, 2026

(54) NETWORK DEVICE AND RECOMMENDATION METHOD FOR SWITCHING CONNECTION

(71) Applicant: Senao Networks, Inc., Taoyuan (TW)

(72) Inventors: Yu-Cheng Chou, Taoyuan (TW); Cheng-Ta Lee, Taoyuan (TW)

(21) Appl. No.: 19/336,642

(22) Filed: Sep. 23, 2025

(30) Foreign Application Priority Data
Feb. 7, 2025 (TW) 114104653

(51) Int. Cl. H04W 36/30

(52) U.S. Cl. CPC H04W 36/304

(57) ABSTRACT

A network device includes a processor and a transceiver. The processor is configured to determine a recommended device to connect from a plurality of candidate devices based at least on a signal testing report signal. The report signal includes a plurality of pieces of signal quality information corresponding to the user equipment and the plurality of candidate devices, and the report signal is generated by the user equipment. The transceiver is electrically connected with the processor and is configured to receive the report signal from the user equipment and transmit a handover request signal to the user equipment, thereby recommending the user equipment to switch its connection to the recommended device.

### CROSS-REFERENCES TO RELATED APPLICATIONS

This application claims priority to Taiwan Patent Application No. 114104653 filed on Feb. 7, 2025, the entire contents of which are hereby incorporated by reference.

### BACKGROUND OF THE INVENTION

### Field of the Invention

The present invention relates to a network device and a method in a wireless network. More particularly, the present invention relates to a network device in a wireless network and a method for recommending, to user equipment, a network device to which the connection can be switched.

### Descriptions of the Related Art

In a wireless network environment, it often occurs that connections of user equipment (UE) are concentrated on a single serving network device (e.g., an access point), while other nearby serving network devices remain relatively idle. Such uneven distribution of connections often results in certain serving network devices being overloaded, thereby necessitating that the UE switch its connection target. On the other hand, the UE may also need to switch serving network devices for various reasons, such as moving away from the original serving network device, degradation of connection quality, or simply user preference. To address this, the currently connected serving network device periodically provides the UE with suggestions regarding other candidate serving network devices, thereby recommending that the UE switch its connection to a serving network device deemed "more suitable" by the current serving network device.

To make such recommendations, the current serving network device not only considers the connection status between itself and the user equipment, but also needs to obtain status information (such as signal strength conditions) between the user equipment and other non-connected serving network devices for comprehensive evaluation. However, in the prior art, serving network devices typically use different frequency bands from neighboring devices when configuring channels to reduce signal interference. This results in non-connected serving network devices being unable to directly obtain signal strength information from the user equipment. Instead, they must either perform a background scan by switching to the channel on which the current serving network device and the user equipment are operating, or be equipped with an additional scanning module (e.g., a scanning radio) to acquire such information. More specifically, once the user equipment connects to the current serving network device, the surrounding non-connected serving network devices periodically and rapidly switch to the channel used by the current serving network device to collect signals transmitted by the user equipment. This enables them to determine the signal strength of the user equipment relative to themselves, and to transmit this information back to the current serving network device for aggregation.

However, when each non-connected serving network device performs background scanning by switching channels, it may cause degradation in the connection quality experienced by the user equipment. Additionally, the current serving network device must frequently exchange status information with these non-connected serving network devices, resulting in a significant increase in data exchange volume and computational load among the serving network devices. On the other hand, adding additional scanning modules increases manufacturing costs and occupies internal space within the device, which may in turn lead to an increase in device size. In view of the foregoing, improving the degradation in UE connection quality caused by frequent background scanning, in which candidate serving network devices switch to the main channel for signal evaluation, remains a technical problem urgently to be solved in the relevant technical field of the present invention.

### SUMMARY OF THE INVENTION

In order to at least solve the above technical problems, the present invention provides a network device. The network device may comprise a processor and a transceiver. The processor is configured to determine a recommended device to connect from a plurality of candidate devices in a candidate list based at least on a signal testing report signal, wherein the signal testing report signal comprises a plurality of pieces of signal quality information corresponding to the user equipment and the plurality of candidate devices, and the signal testing report signal is generated by the user equipment. The transceiver is electrically connected with the processor and is configured to receive the signal testing report signal from the user equipment, and to transmit a handover request signal to the user equipment, thereby recommending the user equipment to switch its connection to the recommended device.

Optionally, the transceiver is further configured to transmit a request signal of signal testing to the user equipment, thereby enabling the user equipment to generate the signal testing report signal accordingly.

Optionally, the signal testing report signal is a beacon report response, and the request signal of signal testing is a beacon report request.

Optionally, the plurality of pieces of signal quality information comprises the signal strength between the user equipment and the plurality of candidate devices.

Optionally, the processor is configured to determine the recommended device to connect based on the signal testing report signal and at least one of: an operational status information of the network device, a connection status information between the network device and the user equipment, and a data packet transmission status information of the user equipment.

Optionally, the operational status information of the network device comprises at least one of: a number of user equipment connections of the network device, a maximum number of user equipment connections of the network device, and a channel usage rate of the operating channel of the network device.

Optionally, the connection status information between the network device and the user equipment comprises at least one of: the connection signal strength between the network device and the user equipment, and the number of times the network device has transmitted a handover request signal to the user equipment.

Optionally, the data packet transmission status information of the user equipment comprises at least one of: the packet transmission volume of the user equipment, the packet reception volume of the user equipment, and whether the user equipment continuously transmits data packets.

Optionally, the network device further comprises a storage electrically connected with the processor, wherein the storage is configured to store a plurality of pieces of operational status information corresponding to the plurality of candidate devices, and the plurality of pieces of operational status information comprise: a number of user equipment connections of each of the plurality of candidate devices, a maximum number of user equipment connections of each of the plurality of candidate devices, and a channel usage rate of each of the plurality of candidate devices. The processor is configured to determine the recommended device to connect based on the signal testing report signal and the plurality of pieces of operational status information.

Optionally, the transceiver is further configured to exchange basic service set information with each of the plurality of candidate devices, thereby building the candidate list.

Optionally, the transceiver is further configured to repeatedly transmit the request signal of signal testing to the user equipment based on a time interval, and repeatedly receive an updated signal testing report signal from the user equipment until the user equipment terminates its connection with the network device.

Optionally, the processor is further configured to generate an updated handover request signal based on the updated signal testing report signal, and the transceiver is further configured to transmit the updated handover request signal to the user equipment.

In order to at least solve the above technical problems, the present invention further provides a recommendation method for switching connection. The recommendation method for switching connection is executed by a network device and comprises the following steps: receiving a signal testing report signal from a user equipment; determining a recommended device to connect from a plurality of candidate devices in a candidate list based at least on the signal testing report signal, wherein the signal testing report signal comprises a plurality of pieces of signal quality information corresponding to the user equipment and the plurality of candidate devices, and the signal testing report signal is generated by the user equipment; and transmitting a handover request signal to the user equipment, thereby recommending the user equipment to switch its connection to the recommended device.

Optionally, before receiving the signal testing report signal, the recommendation method for switching connection further comprises: transmitting a request signal of signal testing to the user equipment, thereby enabling the user equipment to generate the signal testing report signal.

Optionally, in the recommendation method for switching connection, the signal testing report signal is a beacon report response, and the request signal of signal testing is a beacon report request.

Optionally, in the recommendation method for switching connection, the plurality of pieces of signal quality information comprises the signal strength between the user equipment and the plurality of candidate devices.

Optionally, in the recommendation method for switching connection, the network device determines the recommended device to connect based on the signal testing report signal and at least one of an operational status information of the network device, a connection status information between the network device and the user equipment, and a data packet transmission status information of the user equipment.

Optionally, in the recommendation method for switching connection, the operational status information of the network device comprises at least one of: a number of user equipment connections of the network device, a maximum number of user equipment connections of the network device, and a channel usage rate of the operating channel of the network device.

Optionally, in the recommendation method for switching connection, the connection status information between the network device and the user equipment comprises at least one of the connection signal strength between the network device and the user equipment, and the number of times the network device has transmitted a handover request signal to the user equipment.

Optionally, in the recommendation method for switching connection, the data packet transmission status information of the user equipment comprises at least one of the packet transmission volume of the user equipment, the packet reception volume of the user equipment, and whether the user equipment continuously transmits data packets.

Optionally, in the recommendation method for switching connection, the network device stores a plurality of pieces of operational status information corresponding to the plurality of candidate devices, and the network device determines the recommended device to connect based on the signal testing report signal and the plurality of pieces of operational status information, wherein the plurality of pieces of operational status information comprise the number of user equipment connections of each of the plurality of candidate devices, the maximum number of user equipment connections of each of the plurality of candidate devices, and the channel usage rate of each of the plurality of candidate devices.

Optionally, the recommendation method for switching connection further comprises: exchanging basic service set information with each of the plurality of candidate devices, thereby building the candidate list.

Optionally, the recommendation method for switching connection further comprises: repeatedly transmitting the request signal of signal testing to the user equipment based on a time interval, and repeatedly receiving an updated signal testing report signal from the user equipment until the user equipment terminates its connection with the network device.

Optionally, the recommendation method for switching connection further comprises: after receiving the updated signal testing report signal, generating an updated handover request signal based on the updated signal testing report signal; and transmitting the updated handover request signal to the user equipment.

In summary, the network device provided by the present invention bases its recommendation on information such as signal strength and channel usage rate scanned by the user equipment itself for surrounding network devices. This approach eliminates the need for each network device to switch to the channel of the currently connected network device and user equipment to perform background scanning, thereby avoiding connection quality degradation caused by background scanning and maintaining connection quality and user experience of the user equipment. As a result, it also eliminates the cost and device space required for additionally installing scanning modules.

The above description is not intended to limit the present invention but merely aims to provide the basic conception of the present invention including the technical problems that can be solved by the present invention, the technical means that can be adopted by the present invention and the technical effects that can be achieved by the present invention. According to the attached drawings and the contents described in the following embodiments, those of ordinary skill in the art can further understand various embodiments of the present invention.

### BRIEF DESCRIPTION OF THE DRAWINGS

FIG. 1 is a schematic diagram of a network device according to one or more embodiments of the present invention.

FIG. 2 is a signaling diagram illustrating how the network device of FIG. 1 recommends a connection switching target to user equipment.

FIG. 3 is a flowchart illustrating a method for recommending a connection switch according to one or more embodiments of the present invention.

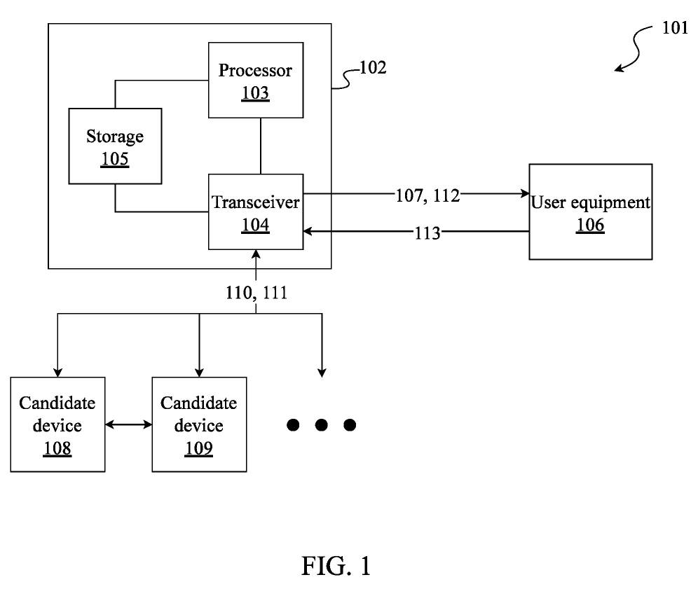

The content shown in FIGS. 1-3 is merely provided as examples for illustrating embodiments of the present invention, and is not intended to limit the scope of the present invention.

### DESCRIPTION OF THE PREFERRED EMBODIMENT

The following embodiments are not intended to limit the claimed invention to a specific environment, application, structure, process, or situation. The attached drawings are only used to assist in explaining the embodiments disclosed below, and are not intended to limit the scope claimed in the present invention. For example, in the attached drawings, elements unrelated to the claimed invention are omitted from depiction. For example, in the attached drawings, dimensions of and dimensional scales among individual elements are only provided as exemplary examples, and are not intended to limit the claimed invention. The same element symbols in the following description may refer to the same elements, unless otherwise specified.

Terms such as “a” or “an” are not used to limit the quantity, and should be regarded as an embodiment that includes a plurality of the same referents. Terms such as “comprising”, “including” and “having” are used to illustrate the existence of features, integers, steps, operations, elements, components and/or groups stated after the terms, but do not exclude the presence or addition of one or more other additional features, integers, steps, operations, elements, components and/or groups thereof. The term “and/or” is used to represent any one or various permutations and combinations of one or more associated items listed. Terms such as “first”, “second” and “third” used to describe the features, integers, steps, operations, elements, components and/or groups stated after the terms are not intended to limit the order of these described objects, but only used to distinguish these described objects.

A first type of embodiment of the present invention is a network device for recommending a connection switching target. Referring to FIG. 1, it illustrates a network device 102 on a wireless network system 101 according to one or more embodiments of the present invention. The network device 102 may be a node in a wireless network topology, configured to establish a wireless connection with user equipment (e.g., a mobile phone, a computer, a wearable electronic device, or an Internet of Things (IoT) device) on the wireless network, and to serve as a server end to provide network services to the user equipment either directly or indirectly. More specifically, the network device 102 may be, but is not limited to, a wireless access point, or another network device in the wireless network topology that integrates access point functionality, such as a router, a switch, or even a smart appliance with integrated access point capabilities.

The network device 102 may comprise at least a processor 103 and a transceiver 104. In some embodiments, the network device 102 may further comprise a storage 105. The processor 103 may be electrically connected to the transceiver 104 and the storage 105, and the transceiver 104 may also be electrically connected to the storage 105. The electrical connections among the processor 103, the transceiver 104, and the storage 105 may be either direct (i.e., connected without intermediate components) or indirect (i.e., connected via one or more intermediate components). Overall, the network device 102 may be configured to provide a handover request signal 107 to a user equipment 106, thereby recommending that the user equipment 106 switch its connection to a network device recommended by the network device 102.

The processor 103 may be a programmable application-specific integrated circuit (ASIC) with capabilities such as computation, storage, and input/output. It may receive and process various encoded instructions to perform logical and arithmetic operations, and output corresponding computation results. The processor 103 may be programmed to interpret various instructions and execute tasks or programs in order to perform the processing described in the present invention. For example, the processor 103 may include, but is not limited to, a central processing unit (CPU), a graphics processing unit (GPU), a digital signal processor (DSP), a microprocessor, and/or a microcontroller.

The transceiver 104 may include a transmitter and a receiver. In the case of wireless communication, the transceiver may include, but is not limited to, communication components such as an antenna, amplifier, modulator, demodulator, detector, analog-to-digital converter, and digital-to-analog converter. In the case of wired communication, the transceiver may be, for example and without limitation, a Gigabit Ethernet transceiver, a Gigabit Interface Converter (GBIC), a Small Form-Factor Pluggable (SFP) transceiver, or a Ten Gigabit Small Form-Factor Pluggable (XFP) transceiver.

The storage 105 may be used to store data generated by the network device 102, data received from external devices, and/or data generated by a user through input/output components (e.g., a combination of components such as a keyboard, mouse, touch panel, and display). For example, the storage 105 may include a first-level memory (also referred to as main memory or internal memory), from which the processor 103 can directly read an instruction set and execute the instructions as needed. The storage 105 may also include a second-level memory (also referred to as external memory or auxiliary memory), which may transfer stored data to the first-level memory through a data buffer. The second-level memory may be, for example and without limitation, a storage medium such as a hard disk or an optical disk. The storage 105 may further include a third-level memory, such as a removable storage device or a cloud storage drive. Depending on the requirements, the storage 105 may include the first-level memory, the second-level memory, and/or the third-level memory.

The wireless network topology in which the network device 102 is located may further include a plurality of candidate network devices (hereinafter referred to as "candidate devices"), such as candidate device 108 and candidate device 109 illustrated in FIG. 1. These candidate devices may be devices that, like the network device 102, are capable of establishing a connection with the user equipment 106 and providing services. When the network device 102 and the user equipment 106 are in a connected state, at least one of the plurality of candidate devices may be recommended by the network device 102 as a target for connection switching.

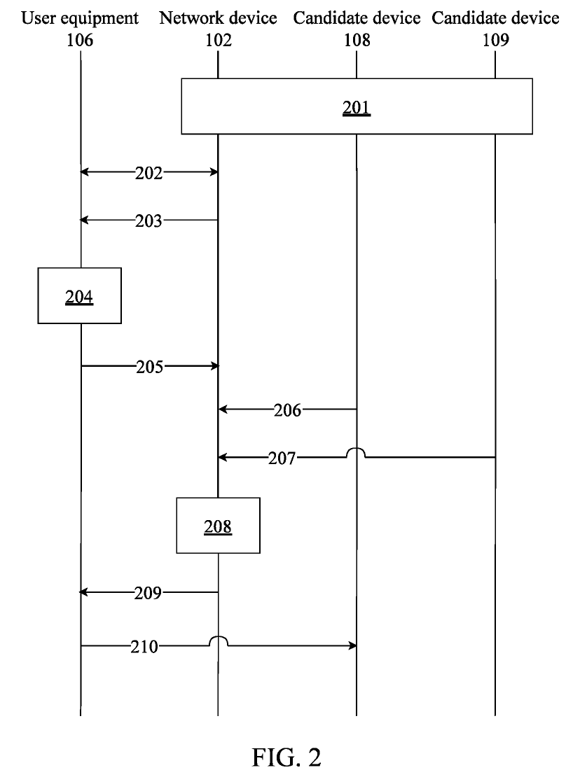

A more detailed example of how the network device 102 recommends a target device for connection switching to the user equipment 106 can be found in FIG. 2, with FIG. 1 provided as a supplementary reference. In action 201, the network device 102 may exchange basic service set (BSS) information 110 with the plurality of candidate devices via the transceiver 104, and at the same time establish and maintain a candidate list (not shown in the figure). The candidate list may include network devices with consistent BSS configurations, including SSID name, encryption method, password, and other settings.

In addition, in some embodiments, the network device 102 may periodically exchange operational status information 111 with the plurality of candidate devices via the transceiver 104, in order to monitor the status of each device. The operational status information 111 may include, for each of the candidate devices, the number of user equipment connections, the maximum number of user equipment connections, the channel utilization rate, and similar data.

Next, in action 202, the network device 102 may establish a connection with the user equipment 106 via the transceiver 104. In other words, the network device 102 becomes the current serving network device of the user equipment 106.

In action 203, in order to obtain information about the signal conditions observed by the user equipment 106 and thereby provide more accurate recommendations for connection switching, the network device 102 may transmit a signal testing request signal 112 to the user equipment via the transceiver 104. In action 204, based on the received signal testing request signal 112, the user equipment 106 may scan the signal strength of surrounding network devices (e.g., wireless access points), generate a signal testing report signal 113, and in action 205, transmit the signal testing report signal 113 to the transceiver 104 of the network device 102. The signal testing report signal 113 may include signal quality information, such as BSS information of surrounding network devices scanned by the user equipment 106, signal strength, and other information related to signal quality. The surrounding network devices may include the plurality of candidate devices, such as candidate device 108 and candidate device 109, unless they cannot be successfully scanned by the user equipment 106.

In some embodiments, one specific example of the signal testing request signal 112 may be a Beacon Report Request according to the IEEE 802.11k standard, and the signal testing report signal 113 may be a Beacon Report Response.

Then, since the signal testing report signal 113 may include signal quality information (for example, BSS information of surrounding network devices scanned by the user equipment 106, signal strength, and other information related to signal quality), in action 208, the processor 103 may determine, based at least on the signal testing report signal 113, one candidate device from the plurality of candidate devices listed in the candidate list that is more suitable for the user equipment 106, as the recommended device. Accordingly, the processor 103 may generate a handover request signal 107, which includes connection-related information of the recommended device (e.g., BSS information). In this manner, the network device 102 not only successfully makes a recommendation regarding the connection switching target, but the basis for the recommendation does not need to rely on conventional background scanning (i.e., surrounding non-connected network devices switching channels to measure the signal strength of the user equipment 106). Instead, it is based on scanning results reported directly by the user equipment 106, which more accurately reflect the actual operating conditions of the user equipment 106.

However, in some embodiments, the processor 103 in action 208 may determine the recommended device not only based on the signal testing report signal 113, but also with reference to additional information. In certain embodiments, the processor 103 may determine the recommended device based on the signal testing report signal 113 and at least one of the following: operational status information of the network device 102, connection status information between the network device 102 and the user equipment 106, and data packet transmission status information of the user equipment 106. More specifically, the operational status information may include at least one of the following: the number of user equipment devices currently connected to the network device 102, the maximum number of user equipment connections allowed by the network device 102, and the channel utilization rate of the channel on which the network device 102 is operating. The connection status information between the network device 102 and the user equipment 106 may include at least one of the following: the connection signal strength between the network device 102 and the user equipment 106, and the number of times the network device 102 has transmitted the handover request signal 107 to the user equipment 106. The data packet transmission status information of the user equipment 106 may include at least one of the following: the packet transmission volume of the user equipment, the packet reception volume of the user equipment, and whether the user equipment 106 is continuously transmitting data packets.

Specifically, in some embodiments, in addition to the signal strength of surrounding network devices measured by the user equipment 106 as indicated in the signal testing report signal 113, the processor 103 may also take into account the status of the network device 102 itself, the status between the network device 102 and the user equipment 106, and/or the status of the user equipment 106, thereby generating a recommendation result that differs from one based solely on the signal testing report signal 113. For example, even if the signal strengths of all candidate network devices indicated in the signal testing report signal 113 are not stronger than the signal strength between the network device 102 and the user equipment 106, the network device 102 may consider its own operational status to be overly busy, and therefore recommend to the user equipment 106 other candidate devices instead of itself. As another example, if the network device 102 has transmitted the handover request signal 107 to the user equipment 106 multiple times up to a threshold (for example, but not limited to, ten times), yet the user equipment 106 still has not switched its connection, this may indicate that the user equipment 106 (or its user) is dissatisfied with the previously recommended result. In such a case, the processor 103 may exclude the previously recommended handover targets from the handover request signal 107 and proceed to recommend other candidate devices.

In some embodiments, in addition to the operational status information of the network device 102, the connection status information between the network device 102 and the user equipment 106, and the packet transmission status information of the user equipment 106, the processor 103 may further refer to information related to the plurality of candidate devices during action 208 to make a recommendation. More specifically, in actions 206 and 207, the transceiver 104 may receive operational status information reported by each candidate device and store it in the storage 105. The transmission of such operational status information may be conducted via wireless or wired transmission paths. Similar to the operational status information of the network device 102, the operational status information of the candidate devices may also include at least one of the following: the current number of user equipment connections established by each candidate device, the maximum number of user equipment connections allowed by each candidate device, and the channel utilization rate of the channels on which the candidate devices operate.

Specifically, in some embodiments, in addition to the signal strength of surrounding network devices measured by the user equipment 106 as indicated in the signal testing report signal 113, the processor 103 may also take into account the status of each candidate device, thereby generating a recommendation result that differs from one based solely on the signal testing report signal 113. For example, if the processor 103 initially intends to recommend candidate device 109 as the preferred choice based on the signal testing report signal 113, but determines that the channel on which candidate device 109 operates is congested, it may instead recommend candidate device 108, which has a lower channel utilization rate. It should be understood that even when the processor 103 additionally considers the current status of each candidate device, the resulting recommendation still does not rely on background scanning performed by each candidate device switching to the operating channel of the network device 102 to scan the user equipment 106.

It should be noted that the timing relationship between action 206 and action 207 shown in FIG. 2 is merely one exemplary implementation and is not an absolute limitation. Actions 206 and 207 may be performed at any point in the timing sequence prior to action 208.

In action 209, the network device 102 may transmit a handover request signal 107 to the user equipment 106 via the transceiver 104. Since the handover request signal 107 indicates the connection information of the recommended device for connection switching, if the user equipment 106 accepts the recommendation, it may proactively switch its connection to the recommended device in action 210. For example, as shown in FIG. 2, the user equipment 106 may switch to candidate device 108, thereby making candidate device 108 the new current serving network device.

If the user equipment 106 does not have a more suitable device to which it can switch its connection (for example, compared to the currently connected network device 102), or if the user equipment 106 insists on maintaining its connection with the network device 102, then actions 203 to 208 may be repeated until the user equipment 106 terminates the connection with the network device 102. More specifically, the transceiver 104 may repeatedly transmit the signal testing request signal 112 to the user equipment 106 at a predetermined time interval (for example, but not limited to, one minute). The user equipment 106 may accordingly update its signal testing report signal 113, and the transceiver 104 may repeatedly receive the updated signal testing report signal 113 from the user equipment 106. The processor 103 may then generate an updated handover request signal 107 based on the updated signal testing report signal 113, and the transceiver 104 may transmit the updated handover request signal 107 to the user equipment 106, thereby allowing the user equipment 106 to refer to the updated connection switching recommendation.

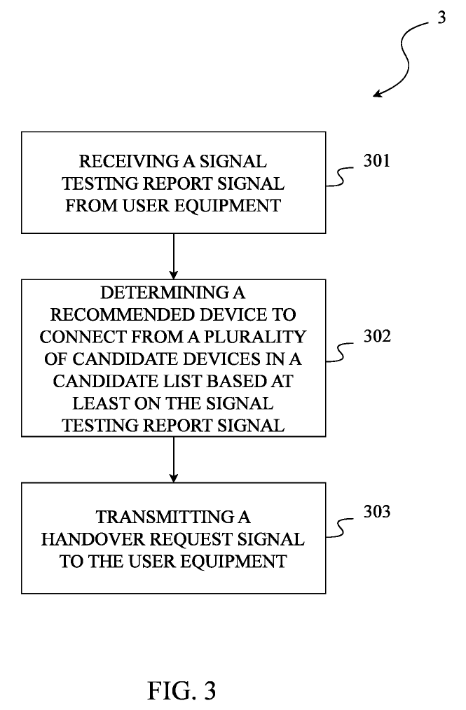

The second type of embodiments of the present invention is a recommendation method for switching connection. Referring to FIG. 3, it illustrates a recommendation method 3 according to one or more embodiments of the present invention. The recommendation method for switching connection may be executed by a network device (for example, but not limited to, the aforementioned network device 102), and may comprise the following steps: receiving a signal testing report signal from a user equipment (indicated as step 301); determining a recommended device to connect from a plurality of candidate devices in a candidate list based at least on the signal testing report signal (indicated as step 302), wherein the signal testing report signal comprises a plurality of pieces of signal quality information corresponding to the user equipment and the plurality of candidate devices, and the signal testing report signal is generated by the user equipment; and transmitting a handover request signal to the user equipment(indicated as step 303), thereby recommending the user equipment to switch its connection to the recommended device.

In some embodiments, before receiving the signal testing report signal, the recommendation method 3 may further comprise the following steps: transmitting a request signal of signal testing to the user equipment, thereby enabling the user equipment to generate the signal testing report signal. In addition, in some embodiments, the signal testing report signal may be a beacon report response, and the request signal of signal testing may be a beacon report request.

In some embodiments, regarding the recommendation method 3, the plurality of pieces of signal quality information comprises the signal strength between the user equipment and the plurality of candidate devices.

In some embodiments, regarding the recommendation method 3, the network device determines the recommended device to connect based on the signal testing report signal and at least one of an operational status information of the network device, a connection status information between the network device and the user equipment, and a data packet transmission status information of the user equipment. Furthermore, in some embodiments, the operational status information of the network device comprises at least one of: a number of user equipment connections of the network device, a maximum number of user equipment connections of the network device, and a channel usage rate of the operating channel of the network device. In some embodiments, the connection status information between the network device and the user equipment comprises: at least one of the connection signal strength between the network device and the user equipment, and the number of times the network device has transmitted a handover request signal to the user equipment. In some embodiments, the data packet transmission status information of the user equipment comprises: at least one of the packet transmission volume of the user equipment, the packet reception volume of the user equipment, and whether the user equipment continuously transmitting data packets.

In some embodiments, regarding the recommendation method 3, the network device stores a plurality of pieces of operational status information corresponding to the plurality of candidate devices, and the network device determines the recommended device to connect based on the signal testing report signal and the plurality of pieces of operational status information, wherein the plurality of pieces of operational status information comprises: a number of user equipment connections of each of the plurality of candidate devices, a maximum number of user equipment connections of each of the plurality of candidate devices, and a channel usage rate of each of the plurality of candidate devices.

In some embodiments, the recommendation method 3 may further comprise the following steps: exchange Basic Service Set (BSS) information with each of the plurality of candidate devices, thereby building the candidate list.

In some embodiments, prior to receiving the signal testing report signal, the recommendation method 3 may further comprise the following steps: transmit the request signal of signal testing to the user equipment, so that the user equipment generates the signal testing report signal accordingly. Additionally, in some embodiments, the recommendation method 3 may further comprise the following steps: repeatedly transmit the request signal of signal testing to the user equipment based on a time interval and repeatedly receive an updated signal testing report signal from the user equipment until the user equipment terminates its connection with the network device. In some embodiments, the recommendation method 3 may further comprise the following steps: after receiving the updated signal testing report signal, generating an updated handover request signal based on the updated signal testing report signal; and transmitting the updated handover request signal to the user equipment.

Each embodiment of the recommendation method 3 generally corresponds to a respective embodiment of the network device 102. Therefore, based solely on the foregoing description of the network device 102, those skilled in the art can fully understand and implement all corresponding embodiments of the recommendation method 3, even if each embodiment of the recommendation method 3 is not described in detail herein.

As described above, the connection switching recommendation scheme provided by the present invention is based on the signal measurement results reported by the user equipment, including information such as signal strength, SSID, and channel status. In certain embodiments, it further takes into account, in a comprehensive manner, the operating status of the network device itself, the connection status between the network device and the user equipment, the operating status of the user equipment, and/or the operating status of the candidate devices. Regardless of the embodiment, the connection switching recommendation scheme of the present invention does not require each network device to switch to the channel of the currently connected network device and the user equipment for background scanning. This avoids the degradation in connection quality caused by background scanning and helps maintain connection quality and user experience for the user equipment. As a result, it also eliminates the cost and device space required for installing additional scanning modules. Moreover, since the connection switching recommendation scheme of the present invention is based on signal measurement results reported by the user equipment, it can more accurately reflect the actual situation perceived by the user equipment, such as the relative distance between the user equipment and each candidate device.

The above embodiments are only examples for illustrating the embodiments of the present invention, and are not intended to limit the scope claimed in the present invention. Any other embodiments produced by modifying, changing, adjusting and integrating the above-mentioned embodiments shall all be included in the scope claimed in the present invention as long as they are not difficult for those of ordinary skill in the art to contemplate. The scope claimed in the present invention shall be governed by the claims.

What is claimed is:

1. A network device, comprising:
a processor, being configured to determine a recommended device to connect from a plurality of candidate devices in a candidate list based at least on a signal testing report signal, wherein the signal testing report signal comprises a plurality of pieces of signal quality information corresponding to the user equipment and the plurality of candidate devices, and the signal testing report signal is generated by the user equipment; and
a transceiver, being electrically connected with the processor and configured to:
receive the signal testing report signal from the user equipment; and
transmit a handover request signal to the user equipment, thereby recommending the user equipment to switch its connection to the recommended device.

2. The network device of claim 1, wherein the transceiver is further configured to transmit a request signal of signal testing to the user equipment, thereby enabling the user equipment to generate the signal testing report signal accordingly;
wherein the signal testing report signal is a beacon report response, and the request signal of signal testing is a beacon report request.

3. The network device of claim 1, wherein:
the transceiver is further configured to exchange basic service set information with each of the plurality of candidate devices, thereby building the candidate list; and
the plurality of pieces of signal quality information comprise signal strength between the user equipment and the plurality of candidate devices.

4. The network device of claim 1, wherein the processor determines the recommended device to connect based on the signal testing report signal and at least one of: an operational status information of the network device, a connection status information between the network device and the user equipment, and a data packet transmission status information of the user equipment.

5. The network device of claim 4, wherein the operational status information of the network device comprises at least one of: a number of user equipment connections of the network device, a maximum number of user equipment connections of the network device, and a channel usage rate of the operating channel of the network device.

6. The network device of claim 4, wherein the connection status information between the network device and the user equipment comprises at least one of: the connection signal strength between the network device and the user equipment, and the number of times the network device has transmitted a handover request signal to the user equipment.

7. The network device of claim 4, wherein the data packet transmission status information of the user equipment comprises at least one of: the packet transmission volume of the user equipment, the packet reception volume of the user equipment, and whether the user equipment continuously transmitting data packets.

8. The network device of claim 1, further comprising a storage, wherein the storage is electrically connected with the processor, and wherein:
the storage is configured to store a plurality of pieces of operational status information corresponding to the plurality of candidate devices, wherein the plurality of pieces of operational status information comprise: a number of user equipment connections of each of the plurality of candidate devices, a maximum number of user equipment connections of each of the plurality of candidate devices, and a channel usage rate of each of the plurality of candidate devices; and
the processor is configured to determine the recommended device to connect based on the signal testing report signal and the plurality of pieces of operational status information.

9. The network device of claim 2, wherein the transceiver is further configured to repeatedly transmit the request signal of signal testing to the user equipment based on a time interval and repeatedly receive an updated signal testing report signal from the user equipment until the user equipment terminates its connection with the network device.

10. The network device of claim 9, wherein the processor is further configured to generate an updated handover request signal based on the updated signal testing report signal, and the transceiver is further configured to transmit the updated handover request signal to the user equipment.

11. A recommendation method for switching connection, being executed by a network device, the recommendation method comprising:
receiving a signal testing report signal from a user equipment;
determining a recommended device to connect from a plurality of candidate devices in a candidate list based at least on the signal testing report signal, wherein the signal testing report signal comprises a plurality of pieces of signal quality information corresponding to the user equipment and the plurality of candidate devices, and the signal testing report signal is generated by the user equipment; and
transmitting a handover request signal to the user equipment, thereby recommending the user equipment to switch its connection to the recommended device.

12. The recommendation method of claim 11, further comprising:
transmitting, before receiving the signal testing report signal, a request signal of signal testing to the user equipment, thereby enabling the user equipment to generate the signal testing report signal;
wherein the signal testing report signal is a beacon report response, and the request signal of signal testing is a beacon report request.

13. The recommendation method of claim 11, further comprising:
exchanging basic service set information with each of the plurality of candidate devices, thereby building the candidate list;
wherein the plurality of pieces of signal quality information comprises the signal strength between the user equipment and the plurality of candidate devices.

14. The recommendation method of claim 11, wherein the network device determines the recommended device to connect based on the signal testing report signal and at least one of: an operational status information of the network device, a connection status information between the network device and the user equipment, and a data packet transmission status information of the user equipment.

15. The recommendation method of claim 14, wherein the operational status information of the network device comprises at least one of: a number of user equipment connections of the network device, a maximum number of user equipment connections of the network device, and a channel usage rate of the operating channel of the network device.

16. The recommendation method of claim 14, wherein the connection status information comprises at least one of: the connection signal strength between the network device and the user equipment, and the number of times the network device has transmitted a handover request signal to the user equipment.

17. The recommendation method of claim 14, wherein the data packet transmission status information of the user equipment comprises at least one of: the packet transmission volume of the user equipment, the packet reception volume of the user equipment, and whether the user equipment continuously transmits data packets.

18. The recommendation method of claim 11, wherein:
the network device stores a plurality of pieces of operational status information corresponding to the plurality of candidate devices;
the network device determines the recommended device to connect based on the signal testing report signal and the plurality of pieces of operational status information; and
the plurality of pieces of operational status information comprises: a number of user equipment connections of each of the plurality of candidate devices, a maximum number of user equipment connections of each of the plurality of candidate devices, and a channel usage rate of each of the plurality of candidate devices.

19. The recommendation method of claim 12, further comprising:
repeatedly transmitting the request signal of signal testing to the user equipment based on a time interval; and
repeatedly receiving an updated signal testing report signal from the user equipment until the user equipment terminates its connection with the network device.

20. The recommendation method of claim 19, further comprising:
generating an updated handover request signal based on the updated signal testing report signal; and
transmitting the updated handover request signal to the user equipment.
